(19) United States
(12) Patent Application Publication
(10) Pub. No.: US 2019/0294037 A1
(43) Pub. Date: Sep. 26, 2019

(54) REAR PROJECTION SCREEN

(71) Applicant: Nano Precision Taiwan Limited, HSINCHU COUNTY (TW)

(72) Inventors: CHIA-HUA CHEN, HSINCHU COUNTY (TW); SHIH-YUAN LIU, HSINCHU COUNTY (TW); FANG-HSUAN SU, HSINCHU COUNTY (TW); CHI-TANG HSIEH, HSINCHU COUNTY (TW)

(21) Appl. No.: 16/351,533

(22) Filed: Mar. 13, 2019

(30) Foreign Application Priority Data
Mar. 21, 2018 (CN) 201820389278.6

(51) Int. Cl. G03B 21/60; G02B 27/09; G02B 5/00; F21V 8/00

(52) U.S. Cl. CPC G03B 21/60; G02B 6/0025; G02B 5/003; G02B 27/0972

(57) ABSTRACT

A rear projection screen includes a prism film, a first diffusion layer, a second diffusion layer and a plurality of light absorbing structures sequentially arranged in a first direction. The prism film includes a first light transmissive substrate and a plurality of prism structures. The first light transmissive substrate has a first surface away from the first diffusion layer. The prism structures are disposed on the first surface. The prism structures receive the image beam and guide the image beam to be transmitted in the first direction. The first diffusion layer and the second diffusion layer have different refractive indices. The light absorbing structures have a gap therebetween. The second diffusion layer has a second surface facing the light absorbing structures. An area occupied by an orthographic projection of the light absorbing structures on the second surface is A1, a total area of the second surface is A2, and 1≤(A2−A1)/A1≤5.

### CROSS-REFERENCE TO RELATED APPLICATION

THIS APPLICATION CLAIMS THE PRIORITY BENEFIT OF CHINA APPLICATION (CN201820389278.6 FILED ON 2018 Mar. 21). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a projection screen, and more particularly to a rear projection screen.

### BACKGROUND OF THE INVENTION

The known rear projection screen has a viewing side (front side) and a back side opposite to each other. The viewing side faces the viewer and the back side faces the projector. The viewing side is provided with prism structures, and the back side is provided with a diffusion layer. The projection beam provided by the projector passes through the diffusion layer and is then refracted to the viewer via the prism structures. The surface of each prism structure facing upward (the direction of the ceiling) is provided with a light absorbing layer, and ambient light can be absorbed by the light absorbing layers or pass through the prism structures without being reflected to the viewer by the rear projection screen, so that the contract of image projected from the projector can be improved.

However, since being provided with a light absorbing layer on the surface of each prism structure facing upward, the above-mentioned rear projection screen can only be applied to the celling hanging projection mode. Moreover, since the diffusion layer faces the projector instead of the viewer, the quality of the image frame is poor, and the so-called hot spot phenomenon may easily happen and affects the comfort of the viewer to view the image projected from the projector.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a rear projection screen to improve the quality of the image.

Other objectives and advantages of the invention can be further understood from the technical features disclosed by the invention.

In order to achieve one or partial or all of the above or other objectives, an embodiment of the invention provides a rear projection screen for receiving an image beam. The rear projection screen includes a prism film, a first diffusion layer, a second diffusion layer and a plurality of light absorbing structures sequentially arranged in a first direction. The prism film includes a first light transmissive substrate and a plurality of prism structures. The first light transmissive substrate has a first surface away from the first diffusion layer. The prism structures are disposed on the first surface. The prism structures receive the image beam and guide the image beam to be transmitted in the first direction. The first diffusion layer and the second diffusion layer have different refractive indices. The light absorbing structures have a gap therebetween. The second diffusion layer has a second surface facing the light absorbing structures. An area occupied by an orthographic projection of the light absorbing structures on the second surface is A1, a total area of the second surface is A2, and 1≤(A2−A1)/A1≤5.

In summary, in the rear projection screen of the embodiment of the invention, since the image beam is refracted by the prism structure and then sequentially passes through the first diffusion layer and the second diffusion layer, the image beam can be uniformly diffused. Therefore, the quality of the image frame is enhanced and the hot spot phenomenon is reduced. Since the light absorbing structures are not disposed on the prism structure, the rear projection screen of the embodiment of the invention is not only suitable for the celling hanging projection mode, but also suitable for the desktop projection mode. Further, by making the area A1 occupied by the orthographic projection of the light absorbing structures on the second surface conform to the relationship of 1≤(A2−A1)/A1≤5, the ambient light resistance, the gain value, and the half gain angle of view can be improved.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view showing the use of a rear projection screen according to an embodiment of the invention;

FIG. 2A is a schematic view of the light absorbing structures in FIG. 1 in the Y-Z plane;

FIG. 2B is a schematic view of the partial light absorbing structures in FIG. 1 in the X-Z plane;

FIG. 3 is a graph showing the luminance of the rear projection screen of the embodiment of the invention at different viewing angles;

FIG. 4 is a schematic view showing the use of a rear projection screen according to another embodiment of the invention; and

FIG. 5 is a schematic view showing the use of a rear projection screen according to another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

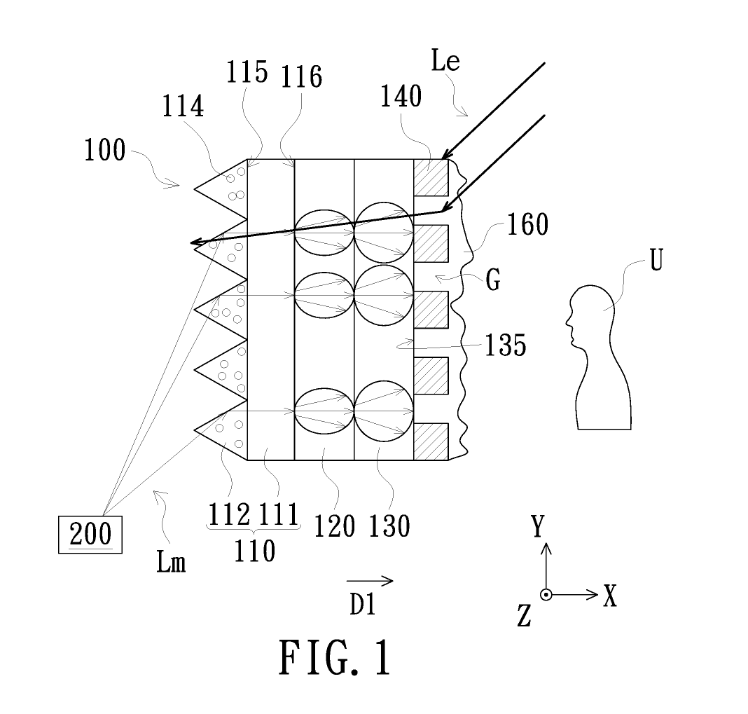

FIG. 1 is a schematic view showing the use of a rear projection screen according to an embodiment of the invention. Referring to FIG. 1, the rear projection screen 100 of the embodiment is used to receive an image beam Lm. The rear projection screen 100 has a viewing side (front side) and a back side opposite to each other, and the image beam Lm is provided by a projector 200 disposed on the back side of the rear projection screen 100. The rear projection screen 100 includes a prism film 110, a first diffusion layer 120, a second diffusion layer 130, and a plurality of light absorbing structures 140 disposed in the first direction D1 (parallel to the X axis, that is, from the back side to the viewing side) in sequence.

The prism film 110 includes a first light transmissive substrate 111 and a plurality of prism structures 112. The prism structures 112 are disposed on the first surface 115 of the first light transmissive substrate 111 away from the first diffusion layer 120. The prism structures 112 receive the image beam Lm from the projector 200 and guide the image beam Lm to pass through the prism film 110 to be sequentially transmitted to the first diffusion layer 120, the second diffusion layer 130 and the light absorbing structures 140 in the first direction D1. Further, the first light transmissive substrate 111 is, for example, a polyethylene terephthalate (PET) substrate or other light transmissive substrate.

Each of the prism structures 112 of the embodiment is, for example, a triangular prism. The prism structures 112 are, for example, arranged parallel to each other along the Y axis, and each prism structure 112 extends along the Z axis, that is, the long axis of each prism structure 112 is parallel to the Z axis. In addition, in other embodiments, the prism structures 112 may also be a Fresnel lens structure distributed concentrically, so the invention does not limit the specific shape and arrangement of the prism structures 112. In addition, diffusing particles 114 may be disposed in each of the prism structures 112 to diffuse the image beam Lm projected from the projector 200.

The first diffusion layer 120 and the second diffusion layer 130 have different refractive indexes, and the first diffusion layer 120 and the second diffusion layer 130 both have light transmissivity, so that the image beam Lm guided from the prism film 110 can pass through the first diffusion layer 120 and the second diffusion layer 130 sequentially and then is transmitted to the light absorbing structures 140. In the embodiment, the first diffusion layer 120 and the second diffusion layer 130 may be formed by the curing of the ultraviolet curing adhesive, and the refractive indexes of the first diffusion layer 120 and the second diffusion layer 130 may be made different by different components of the formulated ultraviolet curing adhesive. In an embodiment, the refractive index of the first diffusion layer 120 is, for example, less than the refractive index of the second diffusion layer 130.

Further, a plurality of first diffusion particles (not shown) may be disposed in the first diffusion layer 120, and a plurality of second diffusion particles (not shown) may be disposed in the second diffusion layer 130. In the embodiment, the particle diameter of the first diffusion particles is ranged between 1 μm to 50 μm for example, the particle diameter of the second diffusion particles is ranged between 200 nm to 800 nm for example, the thickness of the first diffusion layer 120 is 5 μm to 100 μm for example, and the thickness of the diffusion layer 130 is 7 μm to 18 μm for example, but are not limited thereto. In addition, the surface 116 of the first diffusion layer 120 opposite to the first surface 115 may be a rough surface to enhance the diffusion effect.

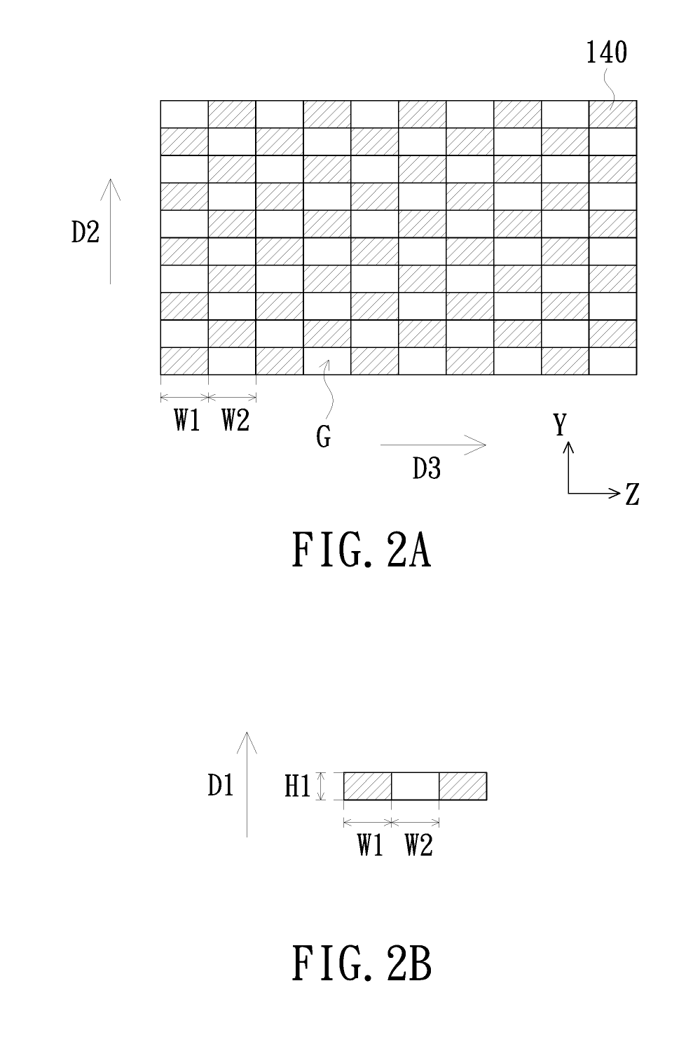

FIG. 2A is a schematic view of the light absorbing structures in FIG. 1 in the Y-Z plane. Referring to FIGS. 1 and 2A, the light absorbing structures 140 have a gap G therebetween. The second diffusion layer 130 has a second surface 135 facing the light absorbing structures 140. The area of the orthographic projection of the light absorbing structures 140 on the second surface 135 of the second diffusion layer 130 is A1, and the total area of the second surfaces 135 is A2, wherein 1≤(A2−A1)/A1≤5. The above (A2−A1) is the area of the orthographic projection of all the gaps G on the second surface 135 of the second diffusion layers 130. In the embodiment, each of the light absorbing structures 140 is, for example, in contact with the second diffusion layer 130. In other words, the light absorbing structures 140 may be directly formed on the second diffusion layer 130, and may be formed by spraying, printing, or the like, but is not limited thereto. In addition, each of the light absorbing structure 140 is, for example, black and has low light transmittance. Therefore, in FIG. 2A, the area where the light absorbing structures 140 are distributed is a black light absorbing area, and the gaps G between the light absorbing structures 140 are a light transmitting area.

In the embodiment, by making the light absorbing structures 140 conform to the relationship: 1≤(A2−A1)/A1≤5, the ambient light Le from different directions can be effectively reduced to the viewer U, thereby reducing the interference caused by the ambient light Le on the viewer U, and the penetration effect of the image beam Lm is taken into consideration.

In an embodiment, the light absorbing structures 140 are, for example, arranged as a plurality of columns in the second direction D2. Each column is parallel to the third direction D3. The second direction D2 and the third direction D3 are, for example, respectively perpendicular to the first direction D1. In FIG. 2A, the second direction D2 is exemplified by being parallel to the Y axis, and the third direction D3 is exemplified by being parallel to the Z axis. In another embodiment, the second direction D2 may be parallel to the Z axis, and the third direction D3 is parallel to the Y axis.

The light absorbing structures 140 in each column are spaced apart, and any of the light absorbing structures 140 in each column corresponds to a gap G between the light absorbing structures 140 in another adjacent column. The width of any of the light absorbing structures 140 in each column in the third direction D3 is W1, and the gap G between the adjacent two light absorbing structures 140 in the third direction D3 is W2. In order to further enhance the display effect of the rear projection screen 100, W1 and W2 may be further made to conform to the following relationship: 3 μm≤W1≤1000 μm and 1≤W2/W1≤5. In addition, referring to FIG. 2B, the height of each light absorbing structure 140 in the first direction D1 is H1 (i.e., the thickness of the light absorbing structure 140), and H1 may be further made to conform to the following relationship: 0.1 μm≤H1≤100 μm.

In the embodiment, the light absorbing structure 140 is, for example, a rectangle (e.g., a cuboid or a cube), so that the orthographic projection of each light absorbing structure 140 on the second surface 135 of the second diffusion layer 130 is a rectangle. The invention does not limit the specific shape of the light absorbing structures 140. In another embodiment, each of the light absorbing structures 140 may also be a partial sphere or a hemisphere, so that the orthographic projection of each light absorbing structure 140 on the second surface 135 is circular, wherein W1 is the diameter of each light absorbing structure 140, and the height H1 of each light absorbing structure 140 is the maximum height of the partial sphere or hemisphere in the first direction D1. In still another embodiment, each light absorbing structure 140 may be an unspecified shape, and correspondingly the orthographic projection of each light absorbing structure 140 on the second surface 135 exhibits an irregular shape, but not limited thereto.

According to the above, when the image beam Lm is incident on the rear projection screen 100, the rear projection screen 100 refracts image beam Lm by the prism structures 112 of the prism film 110 and guides the image beam Lm to be transmitted toward the viewer U, and the image beam Lm sequentially passes through the first diffusion layer 120 and the second diffusion layer 130 in the first direction D1 for diffusion. In the embodiment, the first diffusion layer 120 and the second diffusion layer 130 have different diffusion capabilities. When the image beam Lm sequentially passes through the first diffusion layer 120 and the second diffusion layer 130, the diffusion angle of the image beam Lm gradually increases in the direction away from the prism film 110 (i.e., the first direction D1), so that the quality of the image can be improved and the hot spot phenomenon can be reduced. In addition, the rear projection screen 100 is provided with the light absorbing structures 140, so that the ambient light Le can be prevented from being reflected to the viewer U. Therefore, the prism structures 112 do not need to be provided with a known light absorbing layer. As a result, the rear projection screen 100 of the embodiment of the invention can be applied not only to the desktop projection mode (as shown in FIG. 1), but also to the celling hanging projection mode.

The rear projection screen 100 of the embodiment may further include a diffusion material layer 160. The diffusion material layer 160 has translucency and covers the light absorbing structures 140 and the gaps G between the light absorbing structures 140 (that is, the diffusion material layer 160 is disposed on the second surface 135 of the second diffusion layer 130 facing the viewer U) to enhance the diffusion effect on the image beam Lm.

The computer simulation data is listed below to further illustrate the effects that the rear projection screen 100 of the embodiment can achieve. It should be noted that the following data is only an example and is not intended to limit the invention. In the following table, the gain value (Gain) is the central luminance of white screen in darkroom divided by the maximum luminance of the projector and then multiplied by 3.14. The contrast (C/R) is the central luminance of white screen in brightroom divided by the central luminance of black screen in brightroom. The highest luminance of the rear projection screen is defined as when the viewer views at the center of the rear projection screen. The half gain angle is defined as the measuring angle when the viewer is off the direction of the center axis of the back projection screen and the luminance of the rear projection screen is reduced to half of the maximum luminance.

| | Product | | |
|---|---|---|---|
| | Product 1 | Product 2 | Product 3 |
| Area ratio | (A2 − A1)/A1 = 5 | (A2 − A1)/A1 = 2.3 | (A2 − A1)/ |
| | | | A1 = 1 |
| White in | 234.3 | 220.5 | 176.7 |
| brightroom | | | |
| (nits) | | | |
| Black in | 35.75 | 34.32 | 26.67 |
| brightroom | | | |
| (nits) | | | |
| Gain value | 0.8 | 0.79 | 0.6 |
| (Gain) | | | |
| Contract | 6.55 | 6.41 | 6.62 |
| (C/R) | | | |
| Half gain | >60 degrees | 45 degrees | >60 degrees |
| angle | | | |

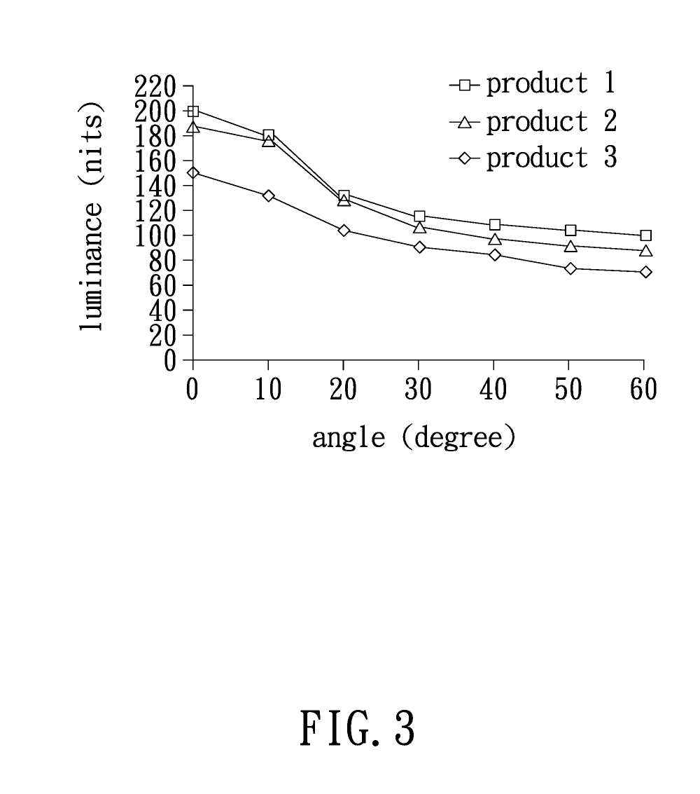

The luminance measured by products 1 to 3 at different viewing angles in the above table is shown in FIG. 3. According to the above table and FIG. 3, it can be seen that the light absorbing structure of products 1 to 3 conforms to the relationship: 1≤(A2−A1)/A1≤5, and therefore the rear projection screen 100 of the embodiment of the invention has preferred ambient light resistance, gain value and half gain angle of view.

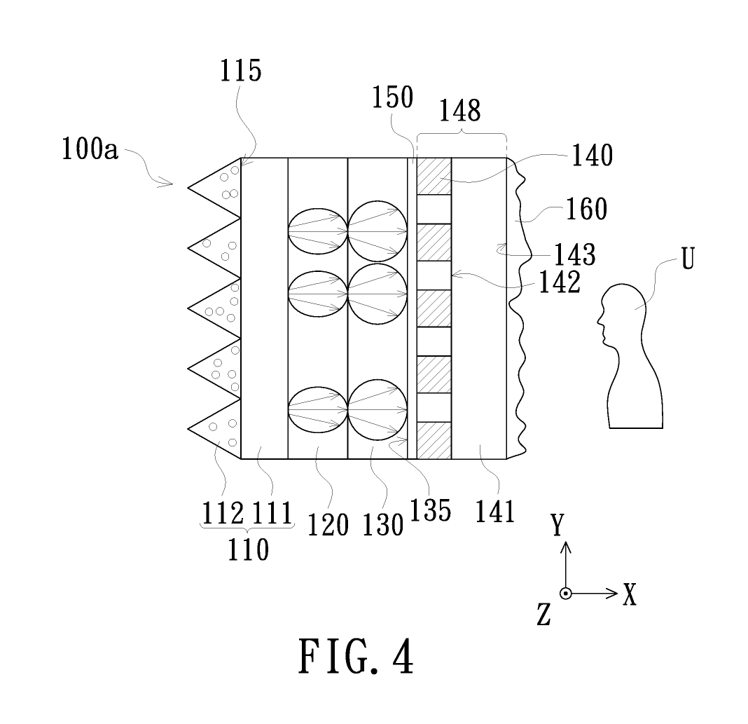

FIG. 4 is a schematic view showing the use of a rear projection screen according to another embodiment of the invention. Referring to FIG. 4, the rear projection screen 100a of the embodiment is similar to the rear projection screen 100. The main difference is that the rear projection screen 100a of the embodiment further includes a second light transmissive substrate 141 for carrying the light absorbing structures 140. The second light transmissive substrate 141 has a surface 142 and a third surface 143 opposite to each other. The light absorbing structures 140 contact the second light transmissive substrate 141, that is, the light absorbing structures 140 are formed on the second light transmissive substrate 141. In the embodiment, the light absorbing structures 140 are, for example, located between the second light transmissive substrate 141 and the second diffusion layer 130. In other words, the light absorbing structures 140 are formed on the surface 142 of the second light transmissive substrate 141 facing the second diffusion layer 130. The second light transmissive substrate 141 is, for example, a PET substrate or other high light transmittance substrate, and the light absorbing structures 140 may be formed on the second light transmissive substrate 141 by spraying or printing. The second light transmissive substrate 141 and the light absorbing structures 140 constitute a light absorbing film 148. Further, in the embodiment, the diffusion material layer 160 covers, for example, the third surface 143 of the second light transmissive substrate 141 away from the light absorbing structures 140.

The rear projection screen 100a further includes a bonding layer 150 bonded between the second diffusion layer 130 and the light absorbing film 148. The bonding layer 150 is, for example, an optical clear adhesive to bond the light absorbing film 148 to the second surface 135 of the second diffusion layer 130. It should be noted that the invention does not limit the use of the bonding layer 150 to couple the second diffusion layer 130 and the light absorbing film 148. The second diffusion layer 130 and the light absorbing film 148 may also be directly coupled to each other.

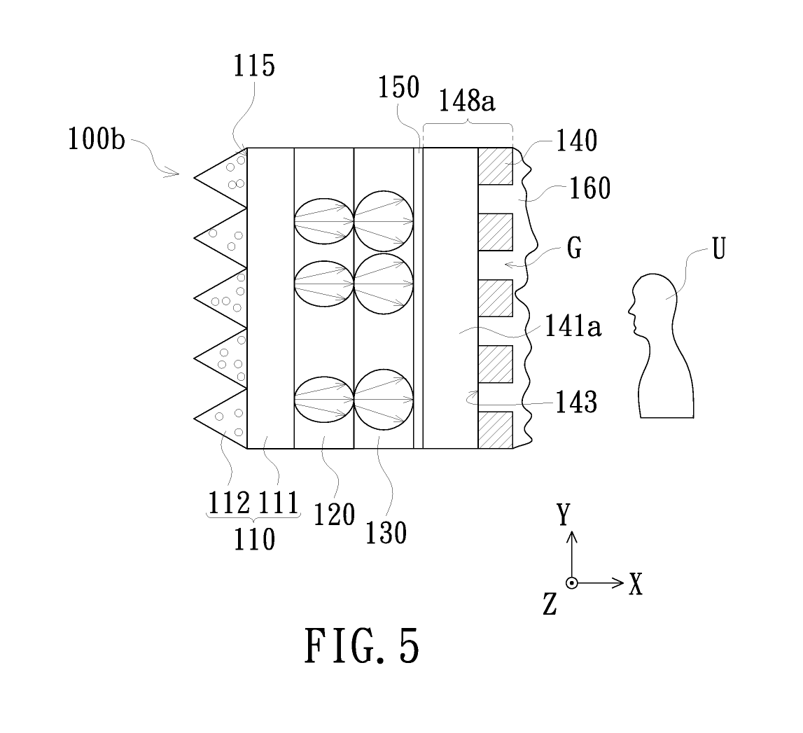

FIG. 5 is a schematic view showing the use of a rear projection screen according to another embodiment of the invention. Referring to FIG. 5, the rear projection screen 100b of the embodiment is similar to the rear projection screen 100a. The main difference is that in the embodiment, the second light transmissive substrate 141a is located between the light absorbing structures 140 and the second diffusion layer 130. In other words, the light absorbing structures 140 are formed on the third surface 143 of the second light transmissive substrate 141 away from the second diffusion layer 130, and the second light transmissive substrate 141a and the light absorbing structures 140 constitute a light absorbing film 148a. Further, the diffusion material layer 160 covers, for example, the light absorbing structures 140 and the third surface 143 of the second light transmission substrate 141a.

In summary, in the rear projection screen of the embodiment of the invention, since the image beam is refracted by the prism structures and then sequentially passes through the first diffusion layer and the second diffusion layer, the image beam can be uniformly diffused. Therefore, the quality of the image is enhanced and the hot spot phenomenon is reduced. Since the light absorbing structures are not disposed on the prism structures, the rear projection screen of the embodiment of the invention is not only suitable for the celling hanging projection mode, but also suitable for the desktop projection mode. Further, by making the area A1 occupied by the orthographic projection of the light absorbing structures on the second surface of the second diffusion layer conform to the relationship of 1≤(A2−A1)/A1≤5, the ambient light resistance, the gain value, and the half gain angle of view can be improved.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first diffusion layer, the second diffusion layer, the first direction, the second direction, the first light transmissive substrate, the second light transmissive substrate, the first surface, the second surface, the first diffusion particles, and the second diffusion particles are only used for distinguishing various elements and do not limit the number of the elements.

What is claimed is:

1. A rear projection screen for receiving an image beam, the rear projection screen comprising a prism film, a first diffusion layer, a second diffusion layer and a plurality of light absorbing structures sequentially arranged in a first direction, wherein,
the prism film comprises a first light transmissive substrate and a plurality of prism structures, the first light transmissive substrate has a first surface away from the first diffusion layer, the prism structures are disposed on the first surface, and the prism structures receive the image beam and guide the image beam to be transmitted in the first direction;
the first diffusion layer and the second diffusion layer have different refractive indices; and
the light absorbing structures have a gap therebetween, the second diffusion layer has a second surface facing the light absorbing structures, an area occupied by an orthographic projection of the light absorbing structures on the second surface is A1, a total area of the second surface is A2, and 1≤(A2−A1)/A1≤5.

2. The rear projection screen according to claim 1, further comprising a second light transmissive substrate carrying the light absorbing structures, wherein the light absorbing structures contact the second light transmissive substrate.

3. The rear projection screen according to claim 2, wherein the light absorbing structures are located between the second light transmissive substrate and the second diffusion layer.

4. The rear projection screen according to claim 3, further comprising a diffusion material layer covering a third surface of the second light transmissive substrate away from the light absorbing structures.

5. The rear projection screen according to claim 2, wherein the second light transmissive substrate is located between the light absorbing structures and the second diffusion layer.

6. The rear projection screen according to claim 5, further comprising a diffusion material layer covering the light absorbing structures and the gaps between the light absorbing structures.

7. The rear projection screen according to claim 2, wherein the second light transmissive substrate and the light absorbing structures constitute a light absorbing film, and the rear projection screen further comprises a bonding layer bonded between the second diffusion layer and the light absorbing film.

8. The rear projection screen according to claim 1, wherein the light absorbing structures contact the second diffusion layer.

9. The rear projection screen according to claim 8, further comprising a diffusion material layer covering the light absorbing structures and the gaps between the light absorbing structures.

10. The rear projection screen according to claim 1, wherein the light absorbing structures are arranged as a plurality of columns in a second direction, the second direction is perpendicular to the first direction, the light absorbing structures in each of the columns are spaced apart, and any one of the light absorbing structures in each of the columns corresponds to the gap between the light absorbing structures in another adjacent column.

11. The rear projection screen according to claim 10, wherein a width of any one of the light absorbing structures in each of the columns in the second direction is W1, the gap between the two adjacent light absorbing structures is W2, wherein 3 μm≤W1≤1000 μm, and 1≤W2/W1≤5.

12. The rear projection screen according to claim 1, wherein a height of the light absorbing structures in a direction parallel to the first direction is H1, and 0.1 μm≤H1≤100 μm.

13. The rear projection screen according to claim 1, wherein each of the light absorbing structures comprises a rectangle.

14. The rear projection screen according to claim 1, wherein the prism structures are triangular prisms or are distributed concentrically.

15. The rear projection screen according to claim 1, wherein each of the light absorbing structures comprises a partial sphere or a hemisphere, a diameter of an orthographic projection of each of the light absorbing structures on the second surface is W1, and the gap between two adjacent light absorbing structures is W2, wherein 3 μm≤W1≤1000 μm, and 1≤W2/W1≤5.
